(19) United States
(12) Patent Application Publication
(10) Pub. No.: US 2021/0119247 A1
(43) Pub. Date: Apr. 22, 2021

(54) SULFIDE-BASED LITHIUM-ARGYRODITE ION SUPERCONDUCTORS INCLUDING MULTIPLE CHALCOGEN ELEMENTS AND METHOD FOR PREPARING THE SAME

(71) Applicant: KOREA INSTITUTE OF SCIENCE AND TECHNOLOGY, Seoul (KR)

(72) Inventors: Hyoungchul KIM, Seoul (KR); Byung Kook KIM, Seoul (KR); Hae-Weon LEE, Seoul (KR); Jong Ho LEE, Seoul (KR); Ji-Won SON, Seoul (KR); Kyung Joong YOON, Seoul (KR); Ho Il JI, Seoul (KR); Sangbaek PARK, Seoul (KR); Sungeun YANG, Seoul (KR); Ji-Su KIM, Seoul (KR); Sung Soo SHIN, Seoul (KR); Eu Deum JUNG, Seoul (KR)

(21) Appl. No.: 16/807,095

(22) Filed: Mar. 2, 2020

(30) Foreign Application Priority Data
Oct. 22, 2019 (KR) 10-2019-0131658

(51) Int. Cl. H01M 10/0562; H01M 10/0525; H01M 10/058

(52) U.S. Cl. CPC H01M 10/0562; H01M 2300/0068; H01M 10/058; H01M 10/0525

(57) ABSTRACT

Provided are a sulfide-based lithium-argyrodite ion superconductor containing multiple chalcogen elements and a method for preparing the same. More specifically, provided are a sulfide-based lithium-argyrodite ion superconductor containing multiple chalcogen elements and a method for preparing the same that are capable of significantly improving lithium ion conductivity by substituting a sulfur (S) element in a PS₄³⁻ tetrahedron with a chalcogen element such as a selenium (Se) element, other than the sulfur (S) element, while maintaining an argyrodite-type crystal structure of a sulfide-based solid electrolyte represented by Li₆PS₅Cl.

### CROSS-REFERENCE TO RELATED APPLICATION

This application claims, under 35 U.S.C. § 119A, the benefit of priority to Korean Patent Application No. 10-2019-0131658 filed on Oct. 22, 2019, the entire contents of which are incorporated herein by reference.

### BACKGROUND

### (a) Technical Field

The present invention relates to a sulfide-based lithium-argyrodite ion superconductor containing multiple chalcogen elements and a method for preparing the same. More specifically, the present invention relates to sulfide-based lithium-argyrodite ion superconductor containing multiple chalcogen elements and a method for preparing the same that are capable of significantly improving lithium ion conductivity by substituting a sulfur (S) element in a PS₄³⁻ tetrahedron with a chalcogen element such as a selenium (Se) element, other than the sulfur (S) element, while maintaining an argyrodite-type crystal structure of a sulfide-based solid electrolyte represented by Li₆PS₅Cl.

### (b) Background Art

Secondary battery technologies used for electronic devices such as cellular phones and notebooks as well as vehicles such as hybrid vehicles and electric vehicles require electrochemical devices with better stability and higher energy density.

Currently, conventional secondary battery technologies face limitations on improvement of stability and energy density because most examples thereof have cells based on an organic solvent (organic liquid electrolyte).

Meanwhile, all-solid-state batteries using inorganic solid electrolytes have recently attracted a great deal attention because they are based on technologies that obviate the use of an organic solvent and thus enable cells to be produced in a safer and simpler manner.

However, a material based on lithium-phosphorus-sulfur (Li—P—S, LPS), which is the most representative solid electrolyte for all-solid-state batteries, developed to date, is needed to be actively researched for mass-production due to drawbacks such as low room-temperature lithium ion conductivity, instability of crystal phases, poor atmospheric stability, process restrictions and narrow ranges of high-conductive phase composition ratios.

U.S. Pat. No. 9,899,701 B2 reports Li₆PS₅Cl, which is a lithium-ion-conducting material having an argyrodite-type crystal structure. A crystal phase of Li₆PS₅Cl is composed of lithium (Li), phosphorus (P), sulfur (S) and chlorine (Cl) and is stable because it is produced at a relatively high temperature. Although Li₆PS₅Cl has higher room-temperature lithium ion conductivity of about 2 mS/cm than conventional materials, it should secure high lithium ion conductivity of 5 mS/cm or more for application to next-generation technologies. However, this issue remains unsolved.

The above information disclosed in this Background section is provided only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art.

It is an object of the present invention to provide a lithium-ion-conducting sulfide-based solid electrolyte with high lithium ion conductivity and a method for preparing the same.

The objects of the present invention are not limited to those mentioned above. The objects of the present invention will be clearly understood from the following description and implemented by means described in the claims and combinations thereof.

In one aspect, the present invention provides a lithium-ion-conducting sulfide-based solid electrolyte represented by the following Formula 1 and having an argyrodite-type crystal structure:

Li_{6-b}PS_{4.5-b-a}YₐX_{1+b} [Formula 1]
wherein X includes a halogen element selected from the group consisting of fluorine (F), chlorine (Cl), bromine (Br) and iodine (I) elements and combinations thereof; Y includes a chalcogen element selected from the group consisting of oxygen (O), selenium (Se), tellurium (Te) and combinations thereof; and a and b satisfy the expressions 0<a≤1 and 0<b≤1.

The sulfide-based solid electrolyte may have peaks in ranges of 2θ=15.78°±0.50°, 18.21°±0.50°, 25.73°±0.50°, 30.20°±0.50°, 31.56°±0.50°, 39.98±1.00°, 45.09°±1.00°, 47.93°±1.00°, 52.50°±1.00° and 59.20±1.00° when measuring X-ray diffraction (XRD) patterns using a CuKα-ray.

The sulfide-based solid electrolyte may have a distribution of anionic clusters of PS₄³⁻, PS₃Se³⁻ and PS₂Se₂³⁻.

The sulfide-based solid electrolyte may have peaks in ranges of −12.7±1.50 ppm to −6.3±1.50 ppm, 31.9±1.50 ppm to 34.7±1.50 ppm, and 73.65±1.50 ppm to 75.5±1.50 ppm in a ³¹P-NMR spectrum.

The sulfide-based solid electrolyte may satisfy the following Equation 1:

0.00<I₃₅/I₇₅<0.60 [Equation 1]
wherein I₃₅ is an intensity of a ³¹P-NMR spectrum peak at about 35 ppm; and I₇₅ is an intensity of a ³¹P-NMR spectrum peak at about 75 ppm.

The sulfide-based solid electrolyte may satisfy the following Equation 2:

0.00<I₋₁₀/I₇₅<0.16 [Equation 2]

wherein I₋₁₀ is an intensity of a ³¹P-NMR spectrum peak at about −10 ppm; and I₇₅ is an intensity of a ³¹P-NMR spectrum peak at about 75 ppm.

The sulfide-based solid electrolyte is characterized in that the Raman peak is downshifted compared to a compound having no Y substitution, and the downshift is a decrease in the wave number of 429 cm⁻¹ to 426 cm⁻¹.

The sulfide-based solid electrolyte may satisfy the following Equation 3:

0.00<I₃₇₇/I₄₂₇<0.45 [Equation 3]

wherein I₃₇₇ is an intensity of a Raman spectrum peak at about 377 cm⁻¹; and I₄₂₇ is an intensity of a Raman spectrum peak at about 427 cm⁻¹.

The sulfide-based solid electrolyte may satisfy the following Equation 4:

0.00<I₃₂₇/I₄₂₇<0.15 [Equation 4]

wherein I₃₂₇ is an intensity of a Raman spectrum peak at about 327 cm⁻¹; and I₄₂₇ is an intensity of a Raman spectrum peak at about 427 cm⁻¹.

In another aspect, the present invention provides a method for preparing a lithium-ion-conducting sulfide-based solid electrolyte including preparing a mixture including lithium sulfide (Li₂S), diphosphorus pentasulfide (P₂S₅) and lithium halide (LiX), and grinding the mixture, wherein the grinding of the mixture includes adding a chalcogen element selected from the group consisting of oxygen (O), selenium (Se), tellurium (Te) and a combination thereof, and elemental-substance phosphorus to the mixture to substitute some of the sulfur element with the chalcogen element, as shown in the following Formula 1:

Li_{6-b}PS_{4.5-b-a}YₐX_{1+b} [Formula 1]

wherein X includes a halogen element selected from the group consisting of fluorine (F), chlorine (Cl), bromine (Br) and iodine (I) elements and combinations thereof; Y includes a chalcogen element selected from the group consisting of oxygen (O), selenium (Se), tellurium (Te), and combinations thereof; and a and b satisfy the expressions 0<a≤1 and 0<b≤1.

According to the method, the grinding may include applying a force of 38G or more to the mixture.

The method may further include heat-treating the ground mixture at a temperature of 300° C. to 1,000° C. for 10 seconds to 100 hours.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows results of XRD analysis according to Test Example 1 of the present invention;

FIG. 2 shows results of ³¹P-NMR analysis according to Test Example 2 of the present invention;

FIG. 3 shows results of Raman analysis according to Test Example 3 of the present invention; and

FIG. 4 shows results of measurement of lithium ion conductivity according to Test Example 4 of the present invention.

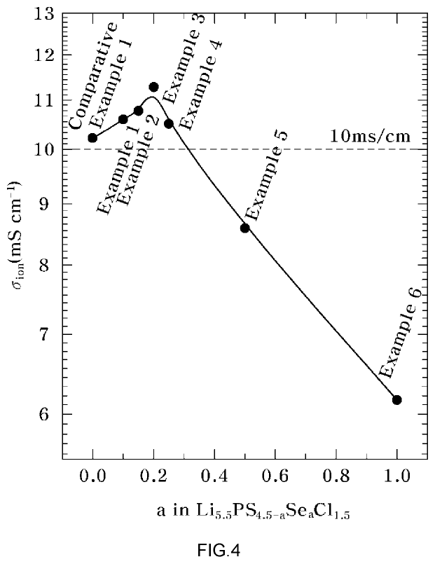

### DETAILED DESCRIPTION

The objects described above, and other objects, features and advantages will be clearly understood from the following preferred embodiments with reference to the attached drawings. However, the present invention is not limited to the embodiments, and may be embodied in different forms. The embodiments are suggested only to offer thorough and complete understanding of the disclosed context and sufficiently inform those skilled in the art of the technical concept of the present invention.

Like reference numbers refer to like elements throughout the description of the figures. In the drawings, the sizes of structures are exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a first element may be referred to as a second element, and similarly, a second element may be referred to as a first element. Singular forms are intended to include plural forms as well, unless the context clearly indicates otherwise.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element, or an intervening element may also be present. It will also be understood that, when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all the numbers, figures and/or expressions. In addition, when numerical ranges are disclosed in the description, these ranges are continuous and include all numbers from the minimum to the maximum including the maximum within the ranges unless otherwise defined. Furthermore, when the range refers to an integer, it includes all integers from the minimum to the maximum including the maximum within the range, unless otherwise defined.

Hereinafter, the sulfide-based lithium-argyrodite ion superconductor containing multiple chalcogen elements and the method for preparing the same will be described in detail. Hereinafter, the sulfide-based lithium-argyrodite ion superconductor containing multiple chalcogen elements is abbreviated as a “sulfide-based solid electrolyte”.

The method for preparing the sulfide-based solid electrolyte according to one embodiment includes preparing a mixture including lithium sulfide (Li₂S), diphosphorus pentasulfide (P₂S₅) and lithium halide (LiX), along with a chalcogen element such as oxygen (O), selenium (Se) or tellurium (Te), and grinding the mixture. In this case, the chalcogen element may be added as a simple substance or a compound containing the same. In particular, oxygen (O) may be added as a compound containing oxygen (O). As used herein, the term “simple substance” refers to a substance that includes only one element and thus exhibits the inherent chemical properties thereof.

The sulfide-based solid electrolyte prepared by the method is a compound represented by the following Formula 1:

Li_{6-b}PS_{4.5-b-a}YₐX_{1+b} [Formula 1]

wherein X includes a halogen element selected from the group consisting of fluorine (F), chlorine (Cl), bromine (Br) and iodine (I) elements and combinations thereof, Y includes a chalcogen element selected from the group consisting of oxygen (O), selenium (Se), tellurium (Te), and combinations thereof, and a and b satisfy the expressions 0<a≤1 and 0<b≤1.

The sulfide-based solid electrolyte has an argyrodite-type crystal structure, which can be clearly seen from the results of X-ray diffraction (XRD) analysis on the sulfide-based solid electrolyte. This will be described later.

The sulfide-based solid electrolyte may further include an element selected from the group consisting of boron (B), carbon (C), nitrogen (N), aluminum (Al), silicon (Si), vanadium (V), manganese (Mn), iron (Fe), cobalt (Co), nickel (Ni), copper (Cu), zinc (Zn), gallium (Ga), germanium (Ge), arsenic (As), silver (Ag), cadmium (Cd), tin (Sn), antimony (Sb), tellurium (Te), lead (Pb), bismuth (Bi) and combinations thereof. The element may be substituted with a phosphorus (P) or sulfur (S) element in the sulfide-based solid electrolyte.

When compared with a conventional material represented by Li_{5.5}PS_{4.5}Cl_{1.5}, the sulfide-based solid electrolyte is characterized in that some of a sulfur (S) element is substituted with a chalcogen element such as oxygen (O), selenium (Se) or tellurium (Te), other than a sulfur element (S). The chalcogen element may be selenium (Se), but is not limited thereto. Although selenium (Se) is a chalcogen group like sulfur (S), it has weaker strain energy when conducting a lithium ion because the ionic radius thereof is larger than that of sulfur (S). Accordingly, by substituting some sulfur (S) elements in a PS₄³⁻ tetrahedron with selenium (Se) elements, like the sulfide-based solid electrolyte according to the present invention, lithium ion conductivity can be improved.

The present inventors were able to successfully substitute only some sulfur (S) elements in a PS₄³⁻ tetrahedron with chalcogen elements without affecting other elements present in the sulfide-based solid electrolyte by conducting the following operations. Hereinafter, the following description will be based on the assumption that the chalcogen element is selenium (Se). However, the chalcogen element of the present invention is not limited thereto. For reference, when the chalcogen element is oxygen (O), as described above, a compound containing oxygen (O) may be used as a raw material.

The method for preparing a sulfide-based solid electrolyte according to the present invention includes the use of selenium (Se) and simple-substance phosphorus in addition to lithium sulfide (Li₂S), diphosphorus pentasulfide (P₂S₅) and lithium halide (LiX) as raw materials.

The raw materials are reorganized into a predetermined crystal structure by vitrification, crystallization or the like. At this time, phosphorus (P) and sulfur (S) atoms agglomerate to form anionic clusters. A change in compositional ratio between lithium (Li), phosphorus (P) and sulfur (S) elements may affect the distribution of the anionic clusters of the sulfide-based solid electrolyte. The present invention includes further adding, as a raw material, in addition to lithium sulfide (Li₂S), diphosphorus pentasulfide (P₂S₅) and lithium halide (LiX), simple-substance phosphorus, rather than a lithium (Li) compound or a sulfur (S) compound, which binds to a sulfur (S) element to form an anionic cluster, to reduce the compositional ratio of the sulfur (S) element, and includes further adding selenium (Se) to incorporate the selenium (Se) element in an amount equivalent to the reduced ratio of sulfur (S) element into the structure of the sulfide-based solid electrolyte.

In addition, the method for preparing a sulfide-based solid electrolyte according to the present invention includes grinding the aforementioned mixture including raw materials by applying a strong force of 38G or more thereto. The selenium (Se) element can be more easily inserted into the crystal structure of the sulfide-based solid electrolyte by grinding the raw materials with a stronger force than that used in conventional preparation methods. The grinding method is not particularly limited, but may be conducted using a ball mill such as an electric ball mill, a vibrating ball mill or planetary ball mill, a vibrating mixer mill, an SPEX mill or the like. Preferably, a planetary ball mill is used. Specifically, when raw materials and beads are charged in a container and a planetary ball mill is then operated, the beads in the container rotate along the wall of the container. At this time, a frictional force is generated, which grinds the raw materials. Here, the rotation rate is increased so as to apply an inertial force of 38G or more to the beads. As a result, the force of 38G or more is applied to the raw materials as well.

In addition, the method for preparing a sulfide-based solid electrolyte according to the present invention may further include heat-treating the ground mixture. The conditions for heat treatment are not particularly limited, but may include a temperature higher than the crystallization temperature of the ground mixture. For example, the heat treatment may be carried out by heat-treating the ground mixture at 300° C. to 1,000° C. for 10 seconds to 100 hours. Through the heat treatment, crystallinity is increased and thus lithium ion conductivity is greatly improved.

The sulfide-based solid electrolyte prepared by the method has properties completely different from those of conventional materials. This will be analyzed by the following Examples and Test Examples.

### Example 1—Synthesis of Li_{5.5}PS_{4.4}Se_{0.1}Cl_{1.5} (a=1; b=0.5; X═Cl; Y═Se)

A mixture containing lithium sulfide (Li₂S), diphosphorus pentasulfide (P₂S₅), lithium chloride (LiCl), selenium (Se) and simple-substance phosphorus (P) at a molar ratio of 0.485:0.117:0.364:0.024:0.010 was prepared.

The mixture was charged in an airtight milling container along with beads made of zirconium oxide and having a diameter of 3 mm. Here, the amount of charged beads was about 30 times the weight of the raw materials. The mixture was ground using the planetary ball mill method generating an inertial force described above. Specifically, the container was rotated so as to apply a force of about 49G to the mixture, and one cycle including 30 minutes of grinding and 30 minutes of standing was repeated 18 times.

After completion of grinding, a powdery sulfide-based solid electrolyte was recovered through appropriate sieving and mortar grinding. The recovered powder was heat-treated in an inert argon gas atmosphere at a temperature of about 500° C. for about 2 hours. After the heat treatment, the powdered sulfide-based solid electrolyte was recovered through appropriate sieving and mortar grinding.

### Example 2—Synthesis of Li_{5.5}PS_{4.35}Se_{0.15}Cl_{1.5} (a=0.15; b=0.5; X═Cl; Y═Se)

A mixture containing lithium sulfide (Li₂S), diphosphorus pentasulfide (P₂S₅), lithium chloride (LiCl), selenium (Se) and simple-substance phosphorus (P) at a molar ratio of 0.478:0.112:0.359:0.036:0.014 was prepared.

Grinding and heat treatment were conducted in the same manner as in Example 1 above to obtain a powdery sulfide-based solid electrolyte.

### Example 3—Synthesis of Li_{5.5}PS_{4.3}Se_{0.2}Cl_{1.5} (a=0.2; b=0.5; X═Cl; Y═Se)

A mixture containing lithium sulfide (Li₂S), diphosphorus pentasulfide (P₂S₅), lithium chloride (LiCl), selenium (Se) and simple-substance phosphorus (P) at a molar ratio of 0.472:0.109:0.354:0.047:0.019 was prepared.

Grinding and heat treatment were conducted in the same manner as in Example 1 above to obtain a powdery sulfide-based solid electrolyte.

### Example 4—Synthesis of Li_{5.5}PS_{4.25}Se_{0.25}Cl_{1.5} (a=0.25; b=0.5; X═Cl; Y═Se)

A mixture containing lithium sulfide (Li₂S), diphosphorus pentasulfide (P₂S₅), lithium chloride (LiCl), selenium (Se) and simple-substance phosphorus (P) at a molar ratio of 0.465:0.105:0.349:0.058:0.023 was prepared.

Grinding and heat treatment were conducted in the same manner as in Example 1 above to obtain a powdery sulfide-based solid electrolyte.

### Example 5—Synthesis of Li_{5.5}PS₄Se_{0.5}Cl_{1.5} (a=0.5; b=0.5; X═Cl; Y═Se)

A mixture containing lithium sulfide (Li₂S), diphosphorus pentasulfide (P₂S₅), lithium chloride (LiCl), selenium (Se) and simple-substance phosphorus (P) at a molar ratio of 0.435:0.087:0.326:0.109:0.043 was prepared.

Grinding and heat treatment were conducted in the same manner as in Example 1 above to obtain a powdery sulfide-based solid electrolyte.

### Example 6—Synthesis of Li_{5.5}PS_{3.5}Se_{1.0}Cl_{1.5} (a=1.0; b=0.5; X═Cl; Y═Se)

A mixture containing lithium sulfide (Li₂S), diphosphorus pentasulfide (P₂S₅), lithium chloride (LiCl), selenium (Se) and simple-substance phosphorus (P) at a molar ratio of 0.385:0.058:0.288:0.192:0.077 was prepared.

Grinding and heat treatment were conducted in the same manner as in Example 1 above to obtain a powdery sulfide-based solid electrolyte.

### Comparative Example 1

A mixture containing lithium sulfide (Li₂S), diphosphorus pentasulfide (P₂S₅) and lithium chloride (LiCl) at a molar ratio of 0.5:0.125:0.375 was prepared.

Grinding and heat treatment were conducted in the same manner as in Example 1 above to obtain a powdery sulfide-based solid electrolyte.

### Test Example 1—Observation of Crystal Structure of Synthesized Sample Through XRD Analysis

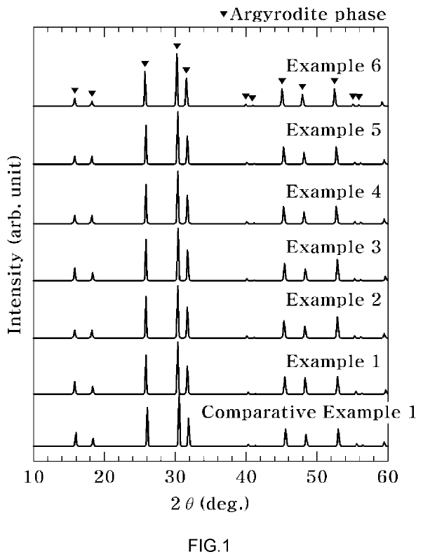

X-ray diffraction (XRD) analysis was conducted in order to analyze the crystal structures of the sulfide-based solid electrolytes according to Examples 1 to 6 and Comparative Example 1. Each sample was loaded on a sealed holder for XRD applications and was measured throughout a range of 10°≤2θ≤60° at a scanning rate of 2°/min. The results are shown in FIG. 1.

As can be seen from FIG. 1, the sulfide-based solid electrolyte showed peaks in ranges of 2θ=15.78°±0.50°, 18.21°±0.50°, 25.73°±0.50°, 30.20°±0.50°, 31.56°±0.50°, 39.98±1.00°, 45.09°±1.00°, 47.93°±1.00°, 52.50°±1.00° and 59.20±1.00° when measuring X-ray diffraction (XRD) patterns using a CuKα-ray. These peaks correspond exactly with the peaks appearing in the crystal structure of argyrodite. Therefore, this indicates that the sulfide-based solid electrolyte according to the present invention has an argyrodite-type crystal structure.

### Test Example 2—Observation of Crystal Characteristics of Synthesized Sample Through ³¹P-NMR Analysis

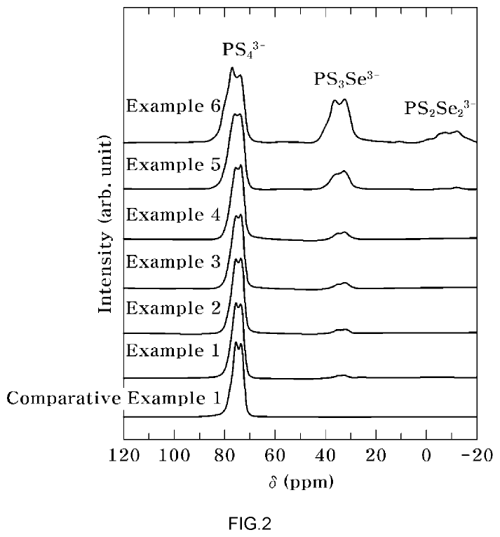

³¹P-NMR analysis was performed to evaluate chemical changes in the sulfide-based solid electrolytes according to Examples 1 to 6 and Comparative Example. Each sample was placed in a sealed container for NMR and measured at a spinning rate of 10,000 Hz using a P31 probe. The received information was converted into a usable data form through Fourier transform. The results are shown in FIG. 2.

As can be seen from FIG. 2, the sulfide-based solid electrolytes according to Examples 1 to 6 showed peaks in ranges of −12.7±1.50 ppm to −6.3±1.50 ppm, 31.9±1.50 ppm to 34.7±1.50 ppm, and 73.65±1.50 ppm to 75.5±1.50 ppm in the ³¹P-NMR spectrum.

When comparing the above results with Comparative Example 1, new peaks were found at −12.7±1.50 ppm to −6.3±1.50 ppm and 31.9±1.50 ppm to 34.7±1.50 ppm. This means that the sulfide-based solid electrolyte according to the present invention has, in addition to PS₄³⁻, newly formed anionic clusters, which correspond respectively to the anionic clusters of PS₂Se₂³⁻ and PS₃Se³.

That is, in the sulfide-based solid electrolyte according to the present invention, a sulfur element (S) is substituted with a selenium element (Se) and has an anionic cluster distribution of PS₄³⁻, PS₃Se³⁻ and PS₂Se₂³⁻, which may be considered to cause significant improvement in lithium ion conductivity, as will be described later.

In addition, the intensity ratio between respective peaks is shown in Table 1 below.

TABLE 1

| Item | I₃₅/I₇₅ | I₋₁₀/I₇₅ |
|---|---|---|
| Example 1 | 0.047 | 0.000 |
| Example 2 | 0.060 | 0.000 |
| Example 3 | 0.092 | 0.000 |
| Example 4 | 0.111 | 0.000 |
| Example 5 | 0.242 | 0.026 |
| Example 6 | 0.582 | 0.159 |
| Comparative Example 1 | 0.000 | 0.000 |

This shows that the sulfide-based solid electrolyte according to the present invention satisfies Equations 1 and 2 below.

0.00<I₃₅/I₇₅<0.60 [Equation 1]

wherein I₃₅ is an intensity of a ³¹P-NMR spectrum peak at about 35 ppm and I₇₅ is an intensity of a ³¹P-NMR spectrum peak at about 75 ppm.

0.00<I₋₁₀/I₇₅<0.16 [Equation 2]

wherein I₋₁₀ is an intensity of a ³¹P-NMR spectrum peak at about −10 ppm and I₇₅ is an intensity of a ³¹P-NMR spectrum peak at about 75 ppm.

### Test Example 3—Observation of Crystal Characteristics of Synthesized Sample Through Raman Analysis

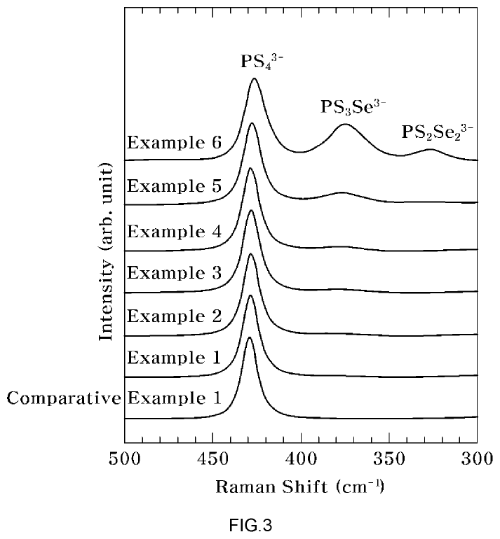

Raman spectroscopy was conducted in order to analyze the crystal characteristics of the sulfide-based solid electrolytes according to Examples 1 to 6 and Comparative Example 1. Each sample was loaded on a sealed holder, the sample was irradiated with an argon-ion laser with a wavelength of 514 nm for 60 seconds and the molecular vibration spectrum of the sample was measured. The results are shown in FIG. 3.

First, as can be seen from the following Table 2, a peak of PS₄³⁻ by about 427 cm⁻¹ of the sulfide-based solid electrolytes according to Examples 1 to 6 is downshifted compared to Comparative Example 1, and the downshift of the peak represents a decrease in the wave number of 429 cm⁻¹ to 426 cm⁻¹.

TABLE 2

| | Wave number at which PS₄³⁻ |
|---|---|
| Item | peak is found (cm⁻¹) |
| Example 1 | 428.90 |
| Example 2 | 428.32 |
| Example 3 | 427.70 |
| Example 4 | 428.30 |
| Example 5 | 427.70 |
| Example 6 | 426.60 |
| Comparative Example 1 | 429.47 |

In addition, compared to Comparative Example 1, the Raman spectrum of the sulfide-based solid electrolytes according to Examples 1 to 6 had a peak of PS₃Se³⁻ at about 377 cm⁻¹ and a peak of PS₂Se₂³⁻ at about 327 cm⁻¹, in addition to the peak of PS₄³⁻ at about 427 cm⁻¹.

The content ratio of PS₄³⁻, PS₃Se³⁻ and PS₂Se₂³⁻ in the anionic cluster can be seen from the intensities of the peaks resulting from PS₄³⁻, PS₃Se³⁻ and PS₂Se₂³ of the Raman spectrum according to FIG. 3. The results are shown in Table 3 below.

TABLE 3

| Item | I₃₇₇/I₄₂₇ | I₃₂₇/I₄₂₇ |
|---|---|---|
| Example 1 | 0.02 | 0.00 |
| Example 2 | 0.03 | 0.00 |
| Example 3 | 0.04 | 0.00 |
| Example 4 | 0.06 | 0.00 |
| Example 5 | 0.15 | 0.04 |
| Example 6 | 0.44 | 0.14 |
| Comparative Example 1 | 0.00 | 0.00 |

This shows that the sulfide-based solid electrolyte according to the present invention satisfies Equations 3 and 4 below.

0.00<I₃₇₇/I₄₂₇<0.45 [Equation 3]

wherein I₃₇₇ is an intensity of a Raman spectrum peak at about 377 cm⁻¹ and I₄₂₇ is an intensity of a Raman spectrum peak at about 427 cm⁻¹.

0.00<I₃₂₇/I₄₂₇<0.15 [Equation 4]

wherein I₃₂₇ is an intensity of a Raman spectrum peak at about 327 cm⁻¹ and I₄₂₇ is an intensity of a Raman spectrum peak at about 427 cm⁻¹.

The above results showed that the sulfide-based solid electrolytes according to Examples 1 to 6 include PS₃Se³⁻ and PS₂Se₂³⁻ in addition to PS₄³⁻ as anionic clusters, among which the content of PS₃Se³⁻ is not less than 1.96% and less than 30.56%.

### Test Example 4—Measurement of Crystal Characteristics of Synthesized Sample Through Measurement of Alternating-Current Impedance

Alternating-current impedance analysis was conducted at room temperature in order to measure the lithium ion conductivity of sulfide-based solid electrolytes according to Examples 1 to 6 and Comparative Example 1. Each powder was charged in a mold for measuring conductivity, and a sample with a diameter of 6 mm and a thickness of 0.6 mm was produced through uniaxial cold pressing at 300 Mpa. An alternating-current voltage of 50 mV was applied to the sample, and a frequency sweep was conducted from 1 Hz to 3 MHz to determine the impedance of the sample. The results are shown in FIG. 2 and Table 4.

TABLE 4

| Item | Lithium ion conductivity (mS/cm) |
|---|---|
| Example 1 | 10.59 |
| Example 2 | 10.77 |
| Example 3 | 11.28 |
| Example 4 | 10.51 |
| Example 5 | 8.59 |
| Example 6 | 6.17 |
| Comparative Example 1 | 10.22 |

As can be seen from the results of Comparative Example 1 and Examples 1 to 6, the sulfide-based solid electrolytes including selenium (Se) according to the present invention (Examples 1 to 4) have higher lithium ion conductivity than a conventional material (Comparative Example 1) represented by Li_{5.5}PS_{4.5}Cl_{1.5}.

The lithium-ion-conducting sulfide-based solid electrolyte containing selenium according to the present invention can be used for all electrochemical cells that use solid electrolytes. Specifically, the lithium-ion-conducting sulfide-based solid electrolyte can be applied to a variety of fields and products, including energy storage systems using secondary batteries, batteries for electric vehicles or hybrid electric vehicles, portable power supply systems for unmanned robots or the Internet of Things, and the like.

As apparent from the foregoing, the lithium-ion-conducting sulfide-based solid electrolyte according to the present invention has high lithium ion conductivity of about 11.28 mS/cm.

The effects of the present invention are not limited to those mentioned above. It should be understood that the effects of the present invention include all effects that can be inferred from the description of the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A lithium-ion-conducting sulfide-based solid electrolyte represented by the following Formula 1 and having an argyrodite-type crystal structure:
Li_{6-b}PS_{4.5-b-a}YₐX_{1+b} [Formula 1]
wherein X comprises a halogen element selected from the group consisting of fluorine (F), chlorine (Cl), bromine (Br) and iodine (I) elements and combinations thereof;
Y comprises a chalcogen element selected from the group consisting of oxygen (O), selenium (Se), tellurium (Te) and combinations thereof; and
a and b satisfy the expressions 0<a≤1 and 0<b≤1.

2. The lithium-ion-conducting sulfide-based solid electrolyte according to claim 1, wherein the sulfide-based solid electrolyte has peaks in ranges of 2θ=15.78°±0.50°, 18.21°±0.50°, 25.73°±0.50°, 30.20°±0.50°, 31.56°±0.50°, 39.98±1.00°, 45.09°±1.00°, 47.93°±1.00°, 52.50°±1.00° and 59.20±1.00° when measuring X-ray diffraction (XRD) patterns using a CuKα-ray.

3. The lithium-ion-conducting sulfide-based solid electrolyte according to claim 1, wherein the sulfide-based solid electrolyte has a distribution of anionic clusters of PS₄³⁻, PS₃Se³⁻ and PS₂Se₂³⁻.

4. The lithium-ion-conducting sulfide-based solid electrolyte according to claim 1, wherein the sulfide-based solid electrolyte has peaks in ranges of −12.7±1.50 ppm to −6.3±1.50 ppm, 31.9±1.50 ppm to 34.7±1.50 ppm, and 73.65±1.50 ppm to 75.5±1.50 ppm in a ³¹P-NMR spectrum.

5. The lithium-ion-conducting sulfide-based solid electrolyte according to claim 1, wherein the sulfide-based solid electrolyte satisfies the following Equation 1:
0.00<I₃₅/I₇₅<0.60 [Equation 1]
wherein I₃₅ is an intensity of a ³¹P-NMR spectrum peak at about 35 ppm; and
I₇₅ is an intensity of a ³¹P-NMR spectrum peak at about 75 ppm.

6. The lithium-ion-conducting sulfide-based solid electrolyte according to claim 1, wherein the sulfide-based solid electrolyte satisfies the following Equation 2:
0.00<I₋₁₀/I₇₅<0.16 [Equation 2]
wherein I₋₁₀ is an intensity of a ³¹P-NMR spectrum peak at about −10 ppm; and
I₇₅ is an intensity of a ³¹P-NMR spectrum peak at about 75 ppm.

7. The lithium-ion-conducting sulfide-based solid electrolyte according to claim 1, wherein a Raman peak is downshifted compared to a compound having no Y substitution, and the downshift is a decrease in a wave number of 429 cm⁻¹ to 426 cm⁻¹.

8. The lithium-ion-conducting sulfide-based solid electrolyte according to claim 1, wherein the sulfide-based solid electrolyte satisfies the following Equation 3:
0.00<I₃₇₇/I₄₂₇<0.45 [Equation 3]
wherein I₃₇₇ is an intensity of a Raman spectrum peak at about 377 cm⁻¹; and
I₄₂₇ is an intensity of a Raman spectrum peak at about 427 cm⁻¹.

9. The lithium-ion-conducting sulfide-based solid electrolyte according to claim 1, wherein the sulfide-based solid electrolyte satisfies the following Equation 4:
0.00≤I₃₂₇/I₄₂₇<0.15 [Equation 4]
wherein I₃₂₇ is an intensity of a Raman spectrum peak at about 327 cm⁻¹; and I₄₂₇ is an intensity of a Raman spectrum peak at about 427 cm⁻¹.

10. A method for preparing a lithium-ion-conducting sulfide-based solid electrolyte comprising:
preparing a mixture containing lithium sulfide (Li₂S), diphosphorus pentasulfide (P₂S₅) and lithium halide (LiX); and
grinding the mixture,
wherein the grinding of the mixture comprises adding a chalcogen element selected from the group consisting of oxygen (O), selenium (Se), tellurium (Te) and a combination thereof, and elemental-substance phosphorus to the mixture to substitute some of the sulfur element with the chalcogen element, as shown in the following Formula 1:
Li_{6-b}PS_{4.5-b-a}YₐX_{1+b} [Formula 1]
wherein X comprises a halogen element selected from the group consisting of fluorine (F), chlorine (Cl), bromine (Br) and iodine (I) elements and combinations thereof;
Y comprises a chalcogen element selected from the group consisting of oxygen (O), selenium (Se), tellurium (Te), and combinations thereof; and
a and b satisfy the expressions 0<a≤1 and 0<b≤1.

11. The method according to claim 10, wherein the lithium-ion-conducting sulfide-based solid electrolyte has an argyrodite-type crystal structure.

12. The method according to claim 10, wherein the grinding comprises applying a force of 38G or more to the mixture.

13. The method according to claim 10, wherein the method further comprises heat-treating the ground mixture at a temperature of 300° C. to 1,000° C. for 10 seconds to 100 hours.
